(19) United States
(12) Patent Application Publication
(10) Pub. No.: US 2019/0385802 A1
(43) Pub. Date: Dec. 19, 2019

(54) SWITCH WITH DUSTPROOF STRUCTURE

(71) Applicant: NIDEC COPAL ELECTRONICS CORPORATION, Tokyo (JP)

(72) Inventor: Manabu SATO, Sano-shi (JP)

(73) Assignee: NIDEC COPAL ELECTRONICS CORPORATION, Tokyo (JP)

(21) Appl. No.: 16/394,420

(22) Filed: Apr. 25, 2019

(30) Foreign Application Priority Data
Jun. 15, 2018 (JP) 2018114497

(51) Int. Cl. H01H 23/06

(52) U.S. Cl. CPC H01H 23/06

(57) ABSTRACT

According to one embodiment, a housing includes a first accommodator and a second accommodator separated by a partition wall which has an opening in a portion thereof. A contact mechanism includes a fixed contact plate and a common terminal, accommodated in the first accommodator, and a movable contact arm placed on the common terminal to be contactable to the fixed contact plate. The operator includes a slider, a button, and a substantially spherical stopper. The slider includes one end portion inserted in the opening so as to be slidable on the movable contact arm. The button is provided in the other end portion of the slider, and the stopper is provided between the one end portion and the other end portion of the slider. The O-ring is provided on the partition wall around the opening, and the stopper is brought into contact with the O-ring.

### CROSS-REFERENCE TO RELATED APPLICATIONS

This application claims priority to and the benefit of JP 2018-114497 filed on Jun. 15, 2018. The disclosure of the above application is incorporated herein by reference.

### FIELD

The present disclosure relates generally to, for example, a sealed-type switch with a dustproof structure.

### BACKGROUND

The statements in this section merely provide background information related to the present disclosure and may not constitute prior art.

For example, a rocker switch has a dustproof structure to prevent entering of dust into the housing. As the dustproof structure, such a method is employed that, for example, a sponge such as of polyurethane is filled into a rear surface side of an operator so as to fill the gap between the operator and the housing (see, for example, JP S60-134255 U). Or there is another method in which an O ring is placed around the switcher provided in the operator, so as to fill the gap between the housing and switcher (see, for example, JP 4772634 B).

In the case of using a sponge such as of polyurethane, the operating environment of the switch is limited because sponges deteriorate easily with oil or the like.

Moreover, when an O ring is used, the number of parts increases and accordingly the number of assembling steps increases.

### SUMMARY

This embodiment provides a switch of a simple structure, which can prevents a gap from being created between the operator and the housing, thereby making it possible to inhibit the degradation by oil or the like.

### DRAWINGS

FIG. 1 is a perspective view showing an example of a switch according to this embodiment.

FIG. 2 is a cross section taken along line II-II in FIG. 1.

FIG. 3 is a partially decomposed perspective view of FIG. 1.

### DETAILED DESCRIPTION

In general, according to one embodiment, a switch includes a housing, a switch mechanism, an operator and an O-ring. The housing includes a first accommodator and a second accommodator separated by a partition wall which has an opening in a portion thereof. The switch mechanism includes a fixed contact plate, a common terminal and a movable contact arm. The fixed contact plate and the common terminal are accommodated in the first accommodator, and the movable contact arm is placed on the common terminal so as to be contactable to the fixed contact plate. The operator includes a slider, a button, and a substantially spherical stopper. The slider includes one end portion inserted in the opening so as to be slidable on the movable contact arm. The button is provided in the other end portion of the slider, and the stopper is provided between the one end portion and the other end portion of the slider. An O-ring is provided on the partition wall around the opening, and the stopper is brought into contact with the O-ring.

The embodiment will now be described with reference to drawings. In the drawings, the same structural elements are denoted by the same reference numerals, respectively.

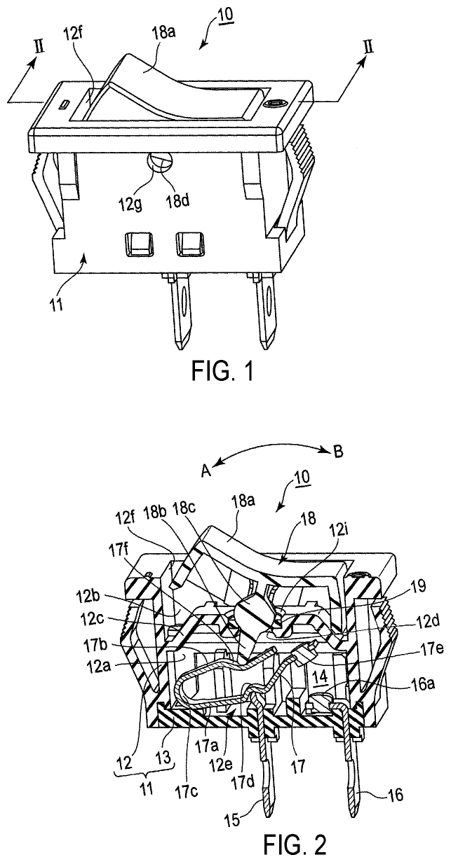

FIGS. 1 and 2 show a switching device 10 according to this embodiment. The switching device 10 includes a housing 11 comprising a main body 12 of the housing and a base plate 13. The base plate 13 is provided in a bottom portion of the main body 12.

The main body 12 comprises a first accommodator 12a and a second accommodator 12b. The first accommodator 12a and the second accommodator 12b are separated by a partition wall 12c. In a central section of the partition wall 12c, for example, a circular opening 12d is formed.

The first accommodator 12a comprises an opening 12e in a bottom portion thereof, and the opening 12e is blocked by the base plate 13.

A contact mechanism (switch mechanism) 14 is provided in the first accommodator 12a. The contact mechanism 14 is constituted by a common terminal 15 provided, for example, in a central portion of the base plate 13, a fixed contact plate 16 provided on a location of the base plate 13 near the common terminal 15, and a movable contact arm 17 mounted on the common terminal 15. The fixed contact plate 16 includes a fixed contact 16a.

The movable contact arm 17 is formed into, substantially, a U shape and includes a first portion 17a, a second portion 17b substantially parallel to the first portion 17a, and a third portion 17c located between the first portion 17a and the second portion 17b.

The central section of the first portion 17a includes a placement portion 17d placed on the common terminal 15, and thus the movable contact arm 17 is tiltable around to the common terminal 15 as a fulcrum. A contact 17e is provided in one end of the first portion 17a, such as to be brought into contact with the fixed contact 16a when the movable contact arm 17 is tilted.

The second portion 17b of the movable contact arm 17 includes a slide portion 17f on which a distal end of a slider 18b of the operator 18, which will be discussed later, can slide. The slide portion 17f is formed into, substantially, a V shape in which a position substantially corresponding to the placement portion 17d is recessed.

The movable contact arm 17 is tiltable around the common terminal 15 as the fulcrum when the distal end of the slider 18b slides on the slide portion 17f.

The second accommodator 12b of the main body 12 of the housing comprises an opening 12f in an upper portion thereof. In the second accommodator 12b, the operator 18 is formed so as to be tiltable.

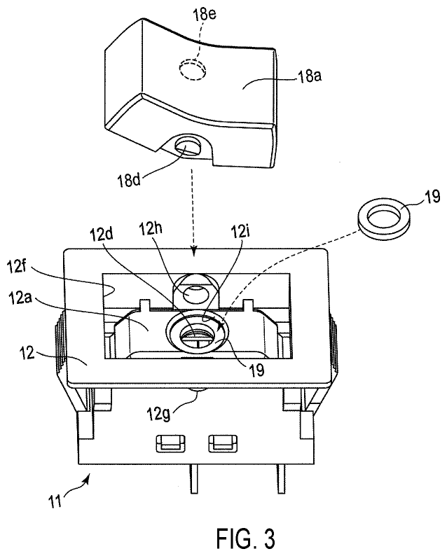

The operator 18 includes a button 18a, a slider 18b as a shaft, a stopper 18c, and supporters 18d and 18e shown in FIG. 3.

The stopper 18c is provided in the middle of the slider 18b, and is formed into substantially a spherical shape whose diameter is greater than that of the opening 12d. The supporters 18d and 18e are formed respectively on both sides of the button 18a. The button 18a, the slider 18b, the stopper 18c, and the supporters 18d and 18e are formed to be integrated as one body.

In the state where the operator 18 is accommodated in the second accommodator 12b, the button 18a is exposed from the opening 12f, and as shown in FIG. 3, the supporters 18d and 18e are engaged in holes 12g and 12h formed in a side wall parallel to the second accommodator 12b. With this structure, the operator 18 is formed to be tiltable with respect to the main body 12 of the housing around the supporters 18d and 18e as the fulcrums.

As shown in FIG. 2, the slider 18b is inserted in the opening 12d of the partition wall 12c, and the distal end thereof is brought into slidably contact with the slide portion 17f of the movable contact arm 17.

As shown in FIG. 3, a slot 12i is formed around the opening 12d of the partition wall 12c, and an O-ring 19 is placed in the slot 12i. The O-ring 19 is formed of rubber into such a shape whose cross section is, for example, rectangular. An inner diameter of the O-ring 19 is equal to or less than the diameter of the opening 12d.

As shown in FIG. 2, the stopper 18c is brought into contact with the O-ring 19 in the state where the slider 18b is inserted to the opening 12d. The O-ring 19, which has a rectangular cross section, is deformed when the stopper 18c is brought into contact with the O-ring 19 so that it is brought into tight contact with an outer surface of the stopper 18c.

Further, the slot 12i has a cross sectional shape similar to that of the O-ring 19. More specifically, the outline of the O-ring 19 is rectangular and the bottom surface and the side surface of the slot 12i are normal to each other. Therefore, the O-ring 19 is tightly attached into the slot 12i, and no gap is created between the O-ring 19 and the slot 12i. In this manner, the gap between the opening 12d and the stopper 18c can be reliably sealed by the O-ring 19.

Note that the cross section of the O-ring 19 is not limited to rectangular, but as long as the gap between the opening 12d and the stopper 18c can sufficiently sealed, an O-ring with a circular cross section can as well be applied. In this case, it is preferable that the slot 12i have an arc shaped cross section so as to fit the O-ring with a circular cross section.

Moreover, when the distance from the opening 12d to the stopper 18c is set slightly shorter than the thickness of the O-ring 19, the stopper 18c can be tightly pressed onto the O-ring 19. In this case, the gap between the stopper 18c and the opening 12d can be sealed even more reliably. The structure is not limited to this, but such means are also applicable that the O-ring 19 deforms due to the weight of the operator 18 itself when the stopper 18c is in contact with the O-ring 19.

In the above-described structure, when the button 18a of the operator 18 is in a position indicated in FIGS. 1 and 2, the contact 17e of the movable contact arm 17 is separated from the fixed contact 16a, thus tuming off the switching device 10. When the button 18a is operated from this state towards a direction indicated by an arrow A in the figure, the operator 18 is tilted around the stopper 18c, and the distal end of the slider 18b slides on the slide portion 17f of the movable contact arm 17. When the distal end of the slider 18b passes the common terminal 15, the movable contact arm 17 is tilted towards a direction indicated by an arrow B in the figure, and the contact 17e is brought into contact with the fixed contact 16a, thus turning on the switching device 10.

When the button 18a is operated in the direction indicated by the arrow B from the state of the switch device being on, the slider 18b moves in reverse to the above-described case, and the switching device 10 is returned to the off state as shown in FIG. 2.

### Advantage of the Embodiment

According to the above-described embodiment, the O-ring 19 is set around the opening 12d of the partition wall 12c and the slider 18b is inserted into the opening 12d. Then, while maintaining this state, the stopper 18c is pressed against the O-ring 19, and thus the opening 12d is blocked by the stopper 18c and the O-ring 19. Because of the elasticity of the O-ring 19, the contact state between the stopper 18c and the O-ring 19 is maintained even if the button 18a is operated. With this structure, even if dust enters the second accommodator 12b, for example, from between the button 18a and the openings 12f, it is still possible to prevent the dust from entering the first accommodator 12a through the opening 12d. Therefore, the contact state of the contact mechanism 14 can be stably maintained.

Moreover, the O-ring 19 is provided around the opening 12d of the partition wall 12c, and therefore the stopper 18c and the O-ring 19 can be brought into tight contact with each other by inserting the slider 18b of the operator 18 into the opening 12d. Therefore, as the operator 18, the button 18a, the slider 18b, the stopper 18c and the supporters 18d and 18e can be formed integrally as one body. Thus, it is possible to reduce the number of parts.

Further, according to this embodiment, the O-ring 19 is placed around the opening 12d of the partition wall 12c, and then the slider 18b of the operator 18 is inserted to the opening 12d and the supporters 18d and 18e of the button 18a are engaged with the holes 12g and 12h formed in the side wall parallel to the second accommodator 12b, thereby completing the assembly. Thus, it is possible to achieve easy assembling and to reduce the number of assembling steps.

Further, the O-ring 19 is a rubber-made member, and is resistant to oil and the like, thereby making it possible to relax restrictions on the operating environment of the switch.

Note that the embodiment described above is directed to the case where it is applied to a rocker switch, but the application is not limited to this. The embodiment can be applied as well to, for example, a lever switch, in which the button 18a has a lever-type shape.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

What is claimed is:

1. A switch comprising:
a housing including a first accommodator and a second accommodator separated by a partition wall comprising an opening in a portion thereof;
a switch mechanism including a fixed contact plate, a common terminal and a movable contact arm, the fixed contact plate and the common terminal being accommodated in the first accommodator, and the movable contact arm being placed on the common terminal and contactable to the fixed contact plate;
an operator including a slider, a button, and a substantially spherical stopper, the slider including one end portion inserted in the opening so as to be slidable on the movable contact arm, the button being provided in the other end portion of the slider, and the stopper being provided between the one end portion and the other end portion of the slider; and
an O-ring provided on the partition wall around the opening, and the stopper being brought into contact with the O-ring.

2. The switch according to claim 1, wherein
the button, the slider, and the stopper of the operator are formed to be integrated as one body.

3. The switch according to claim 1, wherein
the partition wall comprises a slot formed around the opening, and the O-ring is accommodated in the slot.

4. The switch according to claim 3, wherein
the O-ring has a rectangular or circular cross section.

5. The switch according to claim 4, wherein
the slot has a cross sectional shape similar to that of the O-ring.

6. The switch according to claim 5, wherein
the stopper has a diameter greater than a diameter of the opening.

7. A switch comprising:
a housing including a partition wall comprising an opening;
a switch mechanism disposed in the housing partitioned by the partition wall, the switch mechanism including a tiltable movable contact arm;
an operator configured to operate the switch mechanism, the operator including a shaft inserted in the opening and coupled with the switch mechanism and a substantially spherical stopper provided in a longitudinal middle portion of the shaft; and
an O-ring provided on the partition wall around the opening, and the stopper being brought into contact with the O-ring.

8. The switch according to claim 7, wherein
the partition wall comprises a slot formed around the opening, and the O-ring is accommodated in the slot.

9. The switch according to claim 8, wherein
the O-ring has a rectangular or circular cross section.

10. The switch according to claim 9, wherein
the slot has a cross sectional shape similar to that of the O-ring.

11. The switch according to claim 10, wherein
the stopper has a diameter greater than a diameter of the opening.
